(19) United States
(12) Patent Application Publication
(10) Pub. No.: US 2019/0143893 A1
(43) Pub. Date: May 16, 2019

(54) ALERT CONTROL APPARATUS, ALERT CONTROL METHOD, AND RECORDING MEDIUM

(71) Applicant: OMRON Corporation, Kyoto-shi (JP)

(72) Inventors: Tadashi HYUGA, Hirakata-shi (JP); Tomoyoshi AIZAWA, Kyoto-shi (JP); Hatsumi AOI, Kyotanabe-shi (JP); Yoshio MATSUURA, Kasugai-shi (JP); Masato TANAKA, Kizugawa-shi (JP); Keisuke YOKOTA, Kasugai-shi (JP); Hisashi SAITO, Kasugai-shi (JP)

(73) Assignee: OMRON Corporation, Kyoto-shi (JP)

(21) Appl. No.: 16/175,789

(22) Filed: Oct. 30, 2018

(30) Foreign Application Priority Data
Nov. 15, 2017 (JP) 2017-219772

(51) Int. Cl. B60Q 9/00; G06K 9/00

(52) U.S. Cl. CPC B60Q 9/00; H04W 4/44; G06K 9/00845; G06K 9/00335

(57) ABSTRACT

If an alert to distracted driving is disabled, the driver can be alerted insufficiently in situations that take attention. An alert control apparatus (300) includes data obtaining units (41 to 43) that obtain sensing data (a to j) from sensors (6 to 15), a railroad crossing recognizer (44) that recognizes a railroad crossing in front of a vehicle based on the sensing data, and a crossing entry determiner (45) that determines whether the vehicle has entered the railroad crossing based on the sensing data, and a criterion changer (46) that sets, for an area defined in front of the vehicle, a determination criterion defined for causing a distracted driving alert device (200) to generate an alert in response to detection of the vehicle entering the railroad crossing.

### CROSS-REFERENCE TO RELATED APPLICATION

This application claims priority to Japanese Patent Application No. 2017-219772 filed on Nov. 15, 2017, the entire disclosure of which is incorporated herein by reference.

### FIELD

The present invention relates to an alert control apparatus for controlling an alert device that alerts a driver of a vehicle, an alert control method, and a recording medium.

### BACKGROUND

A known alert device alerts a vehicle driver to distracted driving to prompt safety checking. This type of alert device detects the behavior of the vehicle or directly the condition of the driver, and determines distracted driving of the driver based on the detection result. However, distinguishing between underattentive driving and looking in different directions for safety checking is difficult. An alert can sometimes be annoying, or rather dangerous for a driver looking in different directions to check the surroundings for safety. Techniques have thus been developed to correctly recognize the situation and disable an alert to distracted driving as appropriate.

For example, Patent Literature 1 describes a technique for monitoring the operation of the steering wheel or the speed of the vehicle and disabling an alert to distracted driving when the driver is allowed to look in directions other than in front of the vehicle (e.g., when rounding a curve, reversing, or stopping).

### CITATION LIST

### Patent Literature

Patent Literature 1: Japanese Unexamined Patent Application Publication No. 06-243367

### SUMMARY

### Technical Problem

If an alert to distracted driving is disabled, the driver will no longer be annoyed, but can be alerted insufficiently. For example, the Road Traffic Law requires each driver to stop in front of a railroad crossing for safety checking. If an alert to distracted driving is disabled at each temporary stop (during stop), the driver can be alerted insufficiently when passing a railroad crossing.

An alert may also be useful in situations other than when the vehicle is passing a railroad crossing. For example, the driver may pull over the vehicle to the side and stop when an emergency vehicle, such as an ambulance, approaches. In such situations as well, the driver may need to be alerted sufficiently.

One or more aspects of the present invention are directed to an alert control apparatus, a method, and a recording medium that prompt a driver to check safety under situations that take attention in driving.

### Solution to Problem

In response to the above issue, the aspects of the present invention may be implemented in the manner described below.

An alert control apparatus according to a first aspect of the present invention is installable in a vehicle to control an alert device that alerts a driver. The apparatus includes a data obtaining unit that obtains sensing data from a sensor included in the vehicle, a gaze detector that detects a gaze or a face orientation of the driver based on the obtained sensing data, a distracted driving determiner that determines distracted driving of the driver based on the detected gaze or face orientation and a determination criterion for detecting distracted driving of the driver, a controller that causes the alert device to generate an alert in response to detection of distracted driving, and a recognizer that recognizes a situation that takes attention in driving the vehicle based on the obtained sensing data. The controller controls, based on a recognition result from the recognizer, the alert device to prompt the driver to move the gaze in the situation that takes attention in driving the vehicle.

An alert control apparatus according to a second aspect of the prevent invention is the alert control apparatus according to the first aspect in which the controller changes the determination criterion to a determination criterion for prompting the driver to change the gaze or the face orientation in the situation that takes attention in driving the vehicle.

An alert control apparatus according to a third aspect of the present invention is the alert control apparatus according to the second aspect in which the determination criterion includes a retention allowable duration for which the driver is allowed to retain a gaze or a face orientation within an imaginary area defined for detecting distracted driving, and the controller sets a retention allowable duration to retain the gaze or the face orientation within a first area defined in front of the vehicle shorter than a retention allowable duration to retain the gaze or the face orientation within a second area defined in a direction associated with the distracted driving.

An alert control apparatus according to a fourth aspect of the present invention is the alert control apparatus according to the first aspect further including a storage that stores map data including at least position data about a place where attention is to be taken in driving. The sensing data includes position data about the vehicle. The data obtaining unit obtains the position data about the vehicle based on a positioning signal from a positioning system. The recognizer recognizes the situation that takes attention in driving based on the obtained position data about the vehicle and the position data included in the map data.

An alert control apparatus according to a fifth aspect of the present invention is the alert control apparatus according to the first aspect in which the vehicle includes an exterior view camera that obtains image data about a view external to the vehicle, the data obtaining unit obtains the image data from the exterior view camera, and the recognizer subjects the image data to image processing and uses the processed image data to recognize the situation that takes attention in driving.

An alert control apparatus according to a sixth aspect of the present invention is the alert control apparatus according to the first aspect in which the vehicle is configured to communicate with a vehicle-to-roadside communication system or a vehicle-to-vehicle communication system, the data obtaining unit obtains surrounding data about the vehicle from the communication system, and the recognizer recognizes, based on the surrounding data, the situation that takes attention in driving.

An alert control apparatus according to a seventh aspect of the present invention is the alert control apparatus according to any one of the fourth to sixth aspects in which the recognizer recognizes a duration for which the vehicle is passing a railroad crossing as the situation that takes attention in driving.

An alert control apparatus according to an eighth aspect of the present invention is the alert control apparatus according to the fifth or sixth aspect in which the recognizer recognizes an approaching emergency vehicle as the situation that takes attention in driving.

An alert control method according to a ninth aspect of the present invention is implemented by an alert control apparatus installable in a vehicle to control an alert device that alerts a driver. The method includes obtaining, with the alert control apparatus, sensing data from a sensor included in the vehicle, detecting, with the alert control apparatus, a gaze or a face orientation of the driver based on the obtained sensing data, determining, with the alert control apparatus, distracted driving of the driver based on the detected gaze or face orientation and a determination criterion for detecting distracted driving of the driver, causing, with the alert control apparatus, the alert device to generate an alert in response to detection of distracted driving, recognizing, with the alert control apparatus, a situation that takes attention in driving the vehicle based on the obtained sensing data, and controlling, with the alert control apparatus, the alert device to prompt the driver to move the gaze in the situation that takes attention in driving the vehicle based on a recognition result.

A recording medium according to a tenth aspect of the present invention causes a computer to implement processes performed by the units included in the alert control apparatus according to any one of the first to eighth aspects.

### Advantageous Effects

The apparatus, method, and recording medium according to the first, ninth, and tenth aspects control the alert device to generate an alert for prompting the driver to move the gaze in a situation that takes attention in driving. For example, although an alert is typically generated only for retention of the gaze in the direction associated with distracted driving, the structure according to the above aspects generates an alert for retention of the gaze in the front direction as well. This structure prevents the gaze from being retained in the front direction and in specific directions other than the front direction, and thus improves the safety of the vehicle passing a railroad crossing.

The apparatus according to the second aspect changes, in a situation that takes attention in driving, the determination criterion defined for causing the alert device to generate an alert to a criterion for prompting the driver to change the gaze or face orientation. This structure generates an alert intended simply for gaze retention.

The apparatus according to the third aspect sets the retention allowable duration for which the driver is allowed to retain his or her gaze or face orientation within the imaginary area defined for detecting distracted driving for the front direction shorter than for the distracted driving direction in a situation that takes attention in driving. For example, setting the retention allowable duration in minutes for the distracted driving direction and in seconds for the front direction causes an alert to be generated only for the front direction.

The apparatus according to the fourth aspect obtains the position data about the vehicle based on the positioning signal from a positioning system, and recognizes the situation around the vehicle based on the position data about the vehicle and the position data about a place where attention is to be taken in driving (e.g., a railroad crossing) included in the map data. This structure recognizes whether the vehicle is in a situation that takes attention in driving with higher accuracy.

In the apparatus according to the fifth aspect, the exterior view camera installed in the vehicle obtains the exterior image data, which undergoes image processing and is then used to recognize the position of a railroad crossing relative to the vehicle. This structure autonomously recognizes an intended situation without relying on an external resource, such as a positioning system.

The apparatus according to the sixth aspect obtains the surrounding data about the vehicle from a vehicle-to-roadside communication system, which is used to recognize the situation around the vehicle. The simple structure can recognize the situation around the vehicle by, for example, receiving information about the location of a railroad crossing from a vehicle-to-roadside communication system, which may typically be the Vehicle Information and Communication System (VICS, registered trademark), or with a radio wave beacon installed near a railroad crossing.

The apparatus according to the seventh aspect recognizes a duration for which the vehicle is passing a railroad crossing as the situation that takes attention in driving. This structure improves the safety of the vehicle passing a railroad crossing.

The apparatus according to the eighth aspect recognizes an approaching emergency vehicle as the situation that takes attention in driving. This structure improves the safety of the vehicle coming across an emergency vehicle.

### BRIEF DESCRIPTION OF THE DRAWINGS

FIG. 1A is a schematic diagrams describing an example use of an alert control apparatus according to the present embodiment;

FIG. 1B is a schematic diagrams describing an example use of an alert control apparatus according to the present embodiment;

FIG. 2 is a schematic diagram of a vehicle including an alert control apparatus according to the present embodiment;

FIG. 3 is a block diagram of the alert control apparatus according to one or more embodiments;

FIG. 4 is a schematic diagram describing example predetermined retention allowable durations included in a determination criterion;

FIG. 5 is a schematic diagram describing examples of set retention allowable durations included in a determination criterion while a vehicle is passing a railroad crossing; and

FIG. 6 is a flowchart showing an example procedure performed by the alert control apparatus according to one or more embodiments.

### DETAILED DESCRIPTION

### Example Use

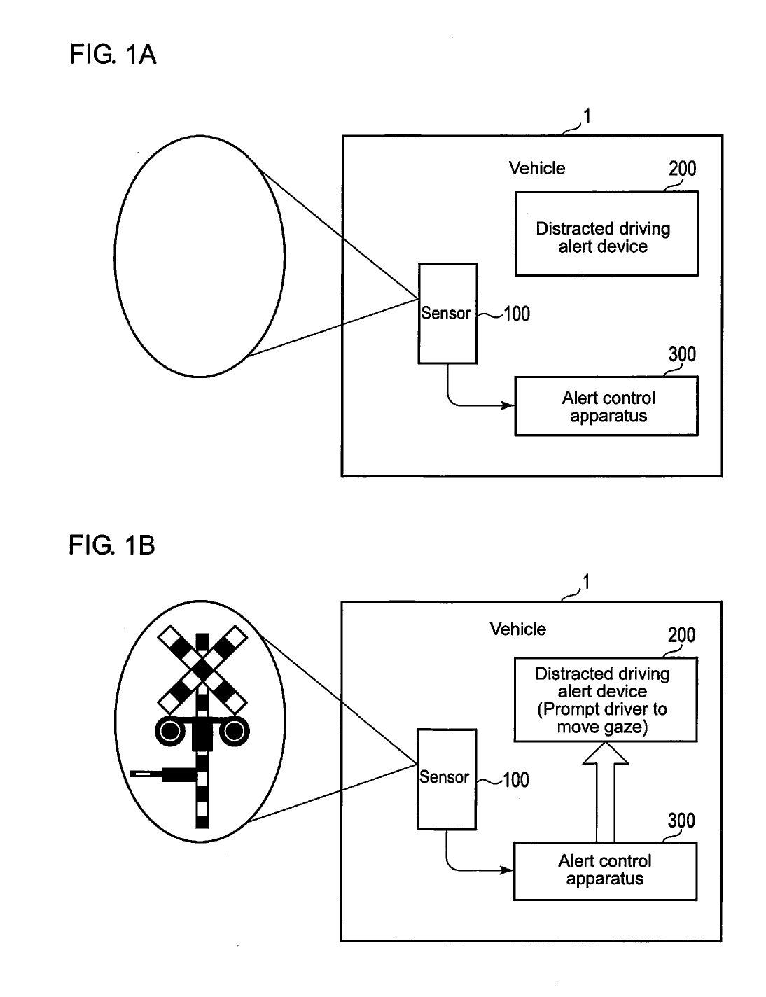

An example use of an alert control apparatus according to one or more embodiments of the present invention will now be described. FIGS. 1A and 1B are schematic diagrams describing an example use of the alert control apparatus according to the present embodiment.

A vehicle 1 includes an alert control apparatus 300 in addition to a sensor 100 and a distracted driving alert device 200. The sensor 100 obtains data about, for example, environments outside and inside the vehicle 1 and the conditions of the driver. For example, the sensor 100 obtains various items of sensing data with, for example, an exterior view camera, an interior view camera, a position measurement sensor such as a global positioning system (GPS) sensor, and a wireless beacon receiver.

The sensing data is transferred to the alert control apparatus 300. The alert control apparatus 300 subjects image data from the interior view camera to image processing to detect the gaze direction or the face orientation of the driver, and causes the distracted driving alert device 200 to generate an alert to distracted driving based on the detection result.

As shown in FIG. 1A, the distracted driving alert device 200 generates an alert to distracted driving when the gaze or face orientation of the driver is retained in a direction other than the traveling direction for a predetermined duration (e.g., several seconds). The alert may be a voice message stating, for example, “Stay alert, and keep your eyes on the road.”

As shown in FIG. 1B, the alert control apparatus 300 controls the distracted driving alert device 200 to prompt the driver to move his or her gaze for safety checking (not only to the front of the vehicle but also in directions other than the front) when the sensor 100 detects, for example, a railroad crossing.

The alert control apparatus 300 operates in the manner described below to prompt the driver to move his or her gaze in a direction associated with distracted driving in a situation that takes attention in driving, such as when the vehicle 1 passes a railroad crossing and when an emergency vehicle is approaching. The operation of the vehicle 1 passing a railroad crossing will now be described.

The alert control apparatus 300 determines whether the vehicle 1 is approaching a railroad crossing using position data about the vehicle 1 obtained from a GPS sensor 12 and map data prestored in, for example, a car navigation system. When the alert control apparatus 300 determines that the vehicle 1 has reached the railroad crossing, the alert control apparatus 300 changes the criterion for distracted driving to prompt the driver to look in the direction associated with distracted driving until the vehicle 1 finishes passing the railroad crossing. For example, when the driver directs his or her face or gaze in the traveling direction of (in front of) the vehicle 1, the alert control apparatus 300 changes the criterion with which this state of the driver is not determined to be distracted driving to a criterion with which an alert is generated for the driver looking in front longer than a predetermined duration while the vehicle 1 is passing the railroad crossing.

This operation prompts the driver driving the vehicle passing a railroad crossing to move his or her gaze laterally for safety checking. This structure can sufficiently alert the driver while the vehicle is passing a railroad crossing, enabling the distracted driving alert device to better achieve its function for safe driving.

In other words, the structure according to one or more embodiments of the present invention has the distracted driving determination function to generate an alert to prompt the driver looking only in front to actively move his or her gaze laterally, or more specifically to enable the driver to check his or her right and left, when the vehicle 1 passes a railroad crossing. This structure facilitates safe driving further.

One or more embodiments of the present invention will now be described in detail.

### Embodiment

### Structure

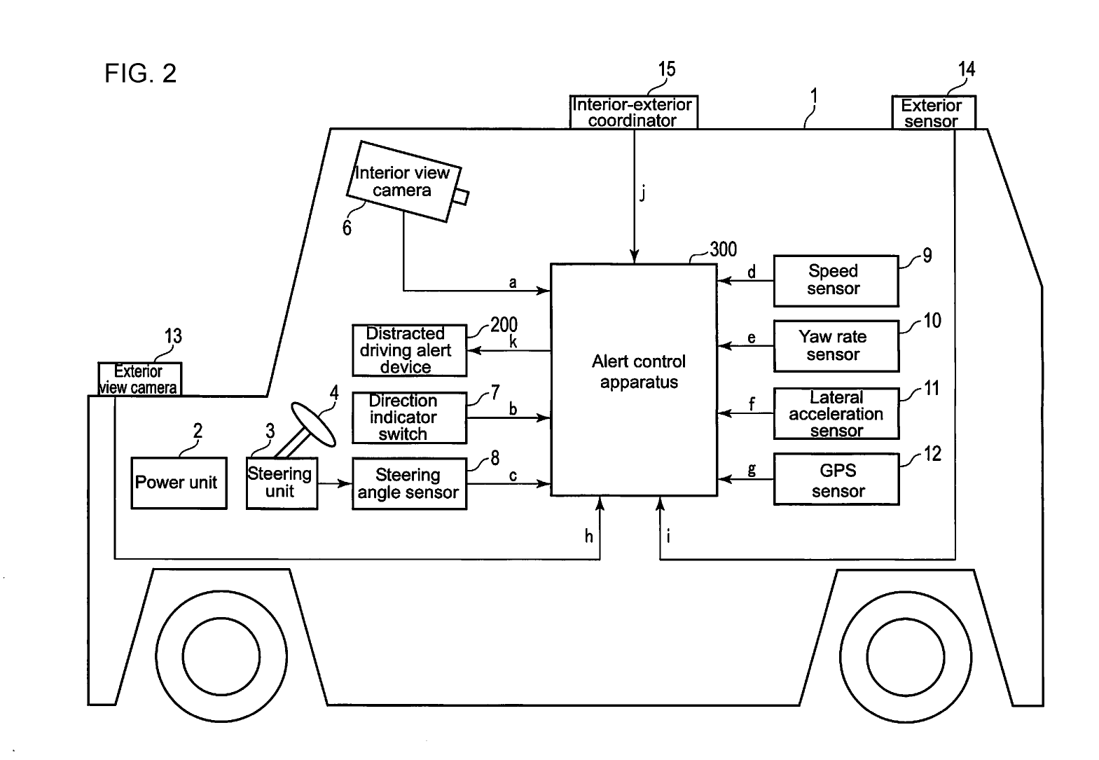

FIG. 2 is a schematic diagram of a vehicle including an alert control apparatus according to the present embodiment. The vehicle 1 includes, as its basic components, a power unit 2 including a power supply and a transmission, and a steering unit 3 incorporating a steering wheel 4. The vehicle 1 further includes, as processing blocks according to the embodiment, the alert control apparatus 300, an interior view camera 6, a direction indicator switch 7, a steering angle sensor 8, a speed sensor 9, a yaw rate sensor 10, a lateral acceleration sensor 11, a position measurement sensor, such as the GPS sensor 12, an exterior view camera 13, an exterior sensor 14, an interior-exterior coordinator 15, and the distracted driving alert device 200.

The alert control apparatus 300 obtains data, such as image data, sensing data, and reception data, from the interior view camera 6, the direction indicator switch 7, the steering angle sensor 8, the speed sensor 9, the yaw rate sensor 10, the lateral acceleration sensor 11, the GPS sensor 12, the exterior view camera 13, the exterior sensor 14, and the interior-exterior coordinator 15. The alert control apparatus 300 causes the distracted driving alert device 200 to generate an alert when detecting, based on the data items, distracted driving of the driver while the vehicle 1 is traveling straight, and causes the distracted driving alert device 200 to function as a distracted driving alert device.

The distracted driving alert device generates an alert using at least the retention duration in the gaze direction of the driver of the vehicle 1 as one criterion. The determination criteria may also include the speed and the steering angle of the vehicle 1.

The interior view camera 6 faces the driver to capture an image of, for example, the upper body of the driver, and outputs an image data signal a to the alert control apparatus 300. The interior view camera 6 may capture images of the driver constantly either while the vehicle 1 is operating or in response to a request from the alert control apparatus 300.

The direction indicator switch 7 outputs, to the alert control apparatus 300, a direction indicator signal b corresponding to a direction in which the driver intentionally redirects the vehicle 1 to turn right or left or to change the lane.

The steering angle sensor 8 outputs, to the alert control apparatus 300, a steering angle signal c corresponding to the steering direction, the neutral position, and the steering angle in accordance with the operation of the steering unit 3.

The speed sensor 9 detects the speed of the vehicle 1, and outputs a detection signal d corresponding to the detected speed to the alert control apparatus 300.

The yaw rate sensor 10 detects the yaw rate of the vehicle 1, and outputs a detection signal e corresponding to the detected yaw rate to the alert control apparatus 300.

The lateral acceleration sensor 11 detects a lateral acceleration of the vehicle 1, and outputs a detection signal f corresponding to the detected lateral acceleration to the alert control apparatus 300.

The GPS sensor 12 detects position data about the vehicle based on position measurement signals transmitted from multiple GPS satellites, and outputs a detection signal g including the detected position data to the alert control apparatus 300. A future example of the GPS sensor 12 may be a positioning system using quasi-zenith satellites called a Japanese version GPS.

The exterior view camera 13 captures images in front of the vehicle 1, and outputs an image data signal h including the image data to the alert control apparatus 300.

The exterior sensor 14 includes, for example, an acoustic sensor, a humidity sensor, a temperature sensor, an infrared sensor, or a radar. The exterior sensor 14 is installed at the vehicle exterior to output a sensing signal i corresponding to detected values to the alert control apparatus 300.

The interior-exterior coordinator 15 receives an external signal transmitted wirelessly including surrounding data about the vehicle 1, such as traffic jam information and map data. The interior-exterior coordinator 15 outputs a received signal j to the alert control apparatus 300. Such surrounding data is provided by a vehicle-to-roadside communication system, such as the Vehicle Information and Communication System (VICS, registered trademark) in Japan. In some embodiments, the surrounding data may be transmitted from a beacon, such as a radio wave beacon, installed near a railroad crossing. In some embodiments, the surrounding data may be transmitted from oncoming vehicles through a vehicle-to-vehicle communication system.

The distracted driving alert device 200 is installed in the vehicle interior to generate an alert in response to the warning instruction signal k from the alert control apparatus 300. Examples of an alert include, in addition to a buzzer sound, a display, light emission, vibrations, and communication to mobile terminals.

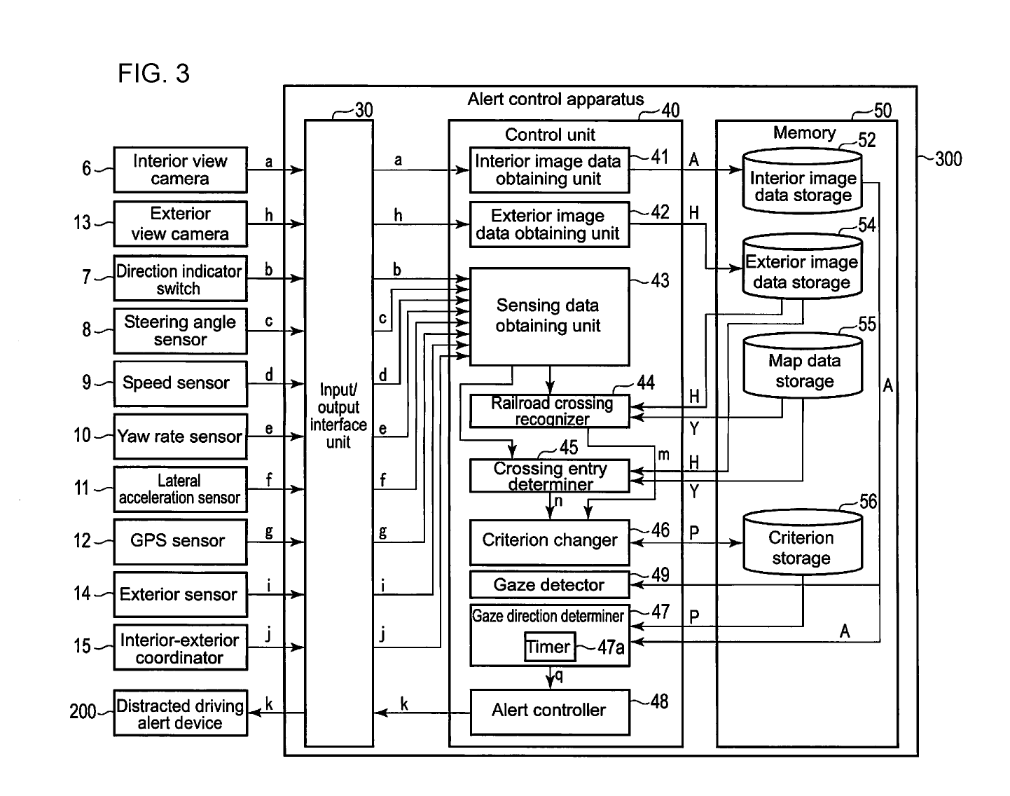

FIG. 3 is a block diagram of the alert control apparatus 300 according to the present embodiment. The alert control apparatus 300 is a computer including a central processing unit (CPU) and a memory. The alert control apparatus 300 includes an input/output interface unit 30, a control unit 40, and a memory 50.

The input/output interface unit 30 receives the image data signal a from the interior view camera 6, the direction indicator signal b from the direction indicator switch 7, the steering angle signal c from the steering angle sensor 8, the detection signal d from the speed sensor 9, the detection signal e from the yaw rate sensor 10, the detection signal f from the lateral acceleration sensor 11, the detection signal g from the GPS sensor 12, the image data signal h from the exterior view camera 13, the sensing signal i from the exterior sensor 14, and the received signal j from the interior-exterior coordinator 15. The input/output interface unit 30, for example, buffers these signals and then transfers them to the control unit 40. The input/output interface unit 30 also outputs a warning instruction signal k received from the control unit 40 to the distracted driving alert device 200.

The memory 50 is, for example, a semiconductor memory, such as a random access memory (RAM), a read only memory (ROM), a flash memory, and a synchronous dynamic RAM (SDRAM), or a non-volatile memory, such as an erasable programmable ROM (EPROM) and an electrically erasable programmable ROM (EEPROM). The memory 50 may also be a storage medium, such as a solid state drive (SSD) and a hard disk drive (HDD). In some embodiments, the memory 50 may be a storage area included in a one-chip microcomputer, such as a field programmable gate array (FPGA).

The memory 50 includes, as storage areas according to the embodiment, an interior image data storage 52, an exterior image data storage 54, a map data storage 55, and a criterion storage 56.

The control unit 40 includes, as functional blocks according to the embodiment, an interior image data obtaining unit 41, an exterior image data obtaining unit 42, a sensing data obtaining unit 43, a railroad crossing recognizer 44, a crossing entry determiner 45, a criterion changer 46, a gaze direction determiner 47, and an alert controller 48. These functional blocks are implemented by the CPU executing programs stored in the program memory.

The interior image data obtaining unit 41 receives the image data signal a transmitted from the interior view camera 6 and output from the input/output interface unit 30, and stores the signal into the interior image data storage 52 as image data A. Thus, the interior image data storage 52 stores the image data A representing the state of the driver.

The exterior image data obtaining unit 42 receives the image data signal h transmitted from the exterior view camera 13 and output from the input/output interface unit 30, and stores the signal into the exterior image data storage 54 as image data H. Thus, the exterior image data storage 54 stores the image data H representing the state of an area in front of the vehicle 1.

The gaze detector 49 detects the gaze or face orientation of the driver from the image data A stored in the interior image data storage 52.

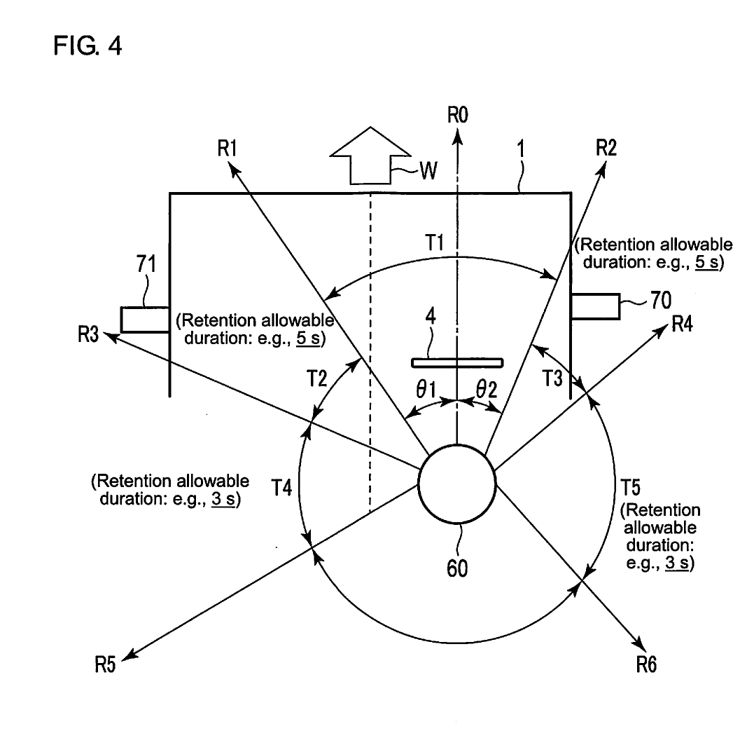

The gaze direction determiner 47 outputs a signal q to the alert controller 48 when detecting distracted driving of the driver 60 based on the gaze or face orientation of the driver detected by the gaze detector 49 and a criterion P stored in the criterion storage 56. The criterion P will now be described with reference to FIG. 4.

FIG. 4 is a schematic diagram describing retention allowable durations as one example of the criterion P. FIG. 4 is a schematic diagram of the vehicle interior viewed from above. FIG. 4 includes a right side mirror 70 and a left side mirror 71.

When the vehicle 1 is traveling straight forward (or upward in the figure) at a normal speed (e.g., 60 km per hour), the gaze direction R of the driver 60 is typically parallel to the traveling direction W of the vehicle 1 or points straight ahead in a gaze direction R0. In this case, the gaze direction R is expected not to deviate leftward from a gaze direction R1 or rightward from a gaze direction R2, although it can slightly move leftward or rightward from the gaze direction R0. A spatial area T1 extends in front of the driver 60.

The driver 60 having his or her gaze direction R within a spatial area different from the area T1 is determined to be engaging in distracted driving. This spatial area is in the direction in which the driver 60 is distracted, or is looking aside (distracted driving direction). The area in the distracted driving direction is not limited to a single area. As shown in FIG. 4, four areas T2 to T5 may be defined in the distracted driving direction. The area T2 is on the left of and adjacent to the area T1. The area T3 is on the right of and adjacent to the area T1. The area T4 is on the rear of and adjacent to the area T2. The area T5 is on the rear of and adjacent to the area T3.

In the example shown in FIG. 4, the area T2 between the gaze directions R1 and R3 and the area T3 between the gaze directions R2 and R4 are asymmetric with respect to the gaze direction R0, and the area T4 between the gaze directions R3 and R5 and the area T5 between the gaze directions R4 and R6 are also asymmetric with respect to the gaze direction R0.

FIG. 4 shows the settings applicable to regions with left-hand traffic. In this example, an angle θ1 between the gaze directions R0 and R1 is greater than an angle θ2 between the gaze directions R0 and R2. The relationship between these angles is reversed in regions with right-hand traffic.

The driver with his or her gaze direction R retained within any of the areas T2 to T5 is determined not to be engaging in distracted driving when the driver changes his or her gaze direction R to another area or to the area T1 in a short time. The length of the retention time set for each area for distracted driving determination herein refers to a retention allowable duration. In other words, the retention allowable duration refers to a duration for which the driver 60 is allowed to retain his or her gaze direction R within the same area without receiving an alert to distracted driving.

The retention allowable duration can be set for each area. In FIG. 4, the retention allowable duration is set at five seconds for the area T2, five seconds for the area T3, three seconds for the area T4, and three seconds for the area T5. In the present embodiment, the retention allowable durations shown in FIG. 4 are predetermined values (default values).

The apparatus according to the present embodiment restricts generation of an alert to distracted driving in the areas T2 to T5 while the vehicle 1 is passing a railroad crossing. For example, the retention allowable durations in the areas T2 to T5 may be extended from the predetermined values in, for example, minutes to restrict generation of an alert to distracted driving in the areas T2 to T5. This is an example of relaxing the criterion set for generating an alert.

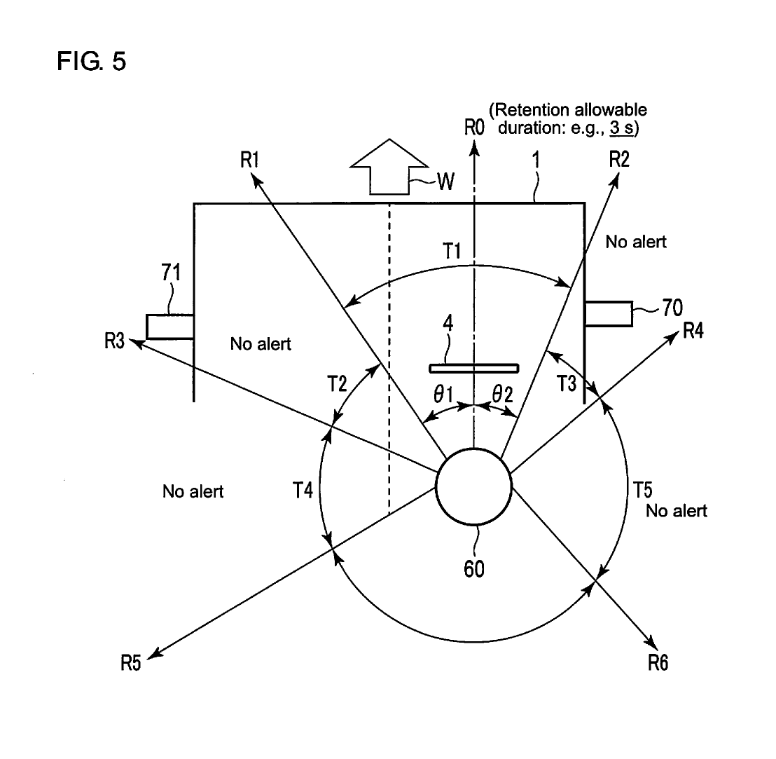

As shown in FIG. 5, the retention allowable duration is set for the area T1, for which no retention allowable duration is set in FIG. 4, while the vehicle 1 is passing a railroad crossing. For example, when the retention allowable duration of three seconds is set for the area T1, the driver looking in front for more than three seconds will receive an alert. This is an example of tightening the criterion set for generating an alert.

Referring back to FIG. 3, the operation will be described continuously. The gaze direction determiner 47 obtains the image data A from the interior image data storage 52 and the criterion P from the criterion storage 56, and determines distracted driving of the driver 60 based on the image data A and the criterion P. More specifically, outside a railroad crossing, the gaze direction determiner 47 does not detect distracted driving when the gaze direction R determined from the face orientation or gaze of the driver 60 in the image data A is within the area T1.

When the gaze direction R is within any of the areas T2 to T5, the gaze direction determiner 47 activates a built-in timer 47a. The timer 47a then counts the time for which the gaze direction R is retained within the same area. The gaze direction determiner 47 determines whether the count reaches the retention allowable duration set for the corresponding area.

When the driver 60 changes his or her gaze direction R to another area or to the area T1 before the count reaches the retention allowable duration, the gaze direction determiner 47 stops the timer 47a and resets the count.

When the count of the timer 47a reaches the retention allowable duration of the corresponding one of the areas T2 to T5, the gaze direction determiner 47 detects distracted driving, and outputs an activation signal q to the alert controller 48 to activate the distracted driving alert device 200.

In response to the activation signal q output from the gaze direction determiner 47, the alert controller 48 outputs the warning instruction signal k to the input/output interface unit 30. The input/output interface unit 30 outputs the warning instruction signal k to the distracted driving alert device 200.

In response to the warning instruction signal k output from the input/output interface unit 30, the distracted driving alert device 200 generates an alert.

The sensing data obtaining unit 43 receives the direction indicator signal b, the steering angle signal c, the detection signal d, the detection signal e, the detection signal f, the detection signal g, the sensing signal i, and the received signal j output from the input/output interface unit 30, and outputs these signals to the railroad crossing recognizer 44 and the crossing entry determiner 45.

The railroad crossing recognizer 44 recognizes the position of a railroad crossing in front of the vehicle 1 based at least on position information G, traffic and other information J, the image data H stored in the exterior image data storage 54, or map data Y stored in the map data storage 55. After recognizing a railroad crossing, the railroad crossing recognizer 44 outputs a crossing recognition signal m to the criterion changer 46.

The crossing entry determiner 45 determines whether the vehicle 1 has entered a railroad crossing based at least on the position information G, the map data Y from the map data storage 55, the traffic and other information J, or the image data H from the exterior image data storage 54. When the image data H is used, the gate of the crossing may be recognized using Open Source Computer Vision Library (OpenCV) to recognize, for example, the positional relationship between the railroad crossing and the vehicle 1 or entry of the vehicle 1 into the railroad crossing. When detecting entry of the vehicle 1 into the railroad crossing, the crossing entry determiner 45 outputs a determination signal n to the criterion changer 46.

When receiving the determination signal n from the crossing entry determiner 45, the criterion changer 46 obtains the criterion P from the criterion storage 56, relaxes the criterion P, and then returns it to the criterion storage 56. The criterion P stored in the criterion storage 56 is updated accordingly. The operation with the above structure will now be described.

### Operation

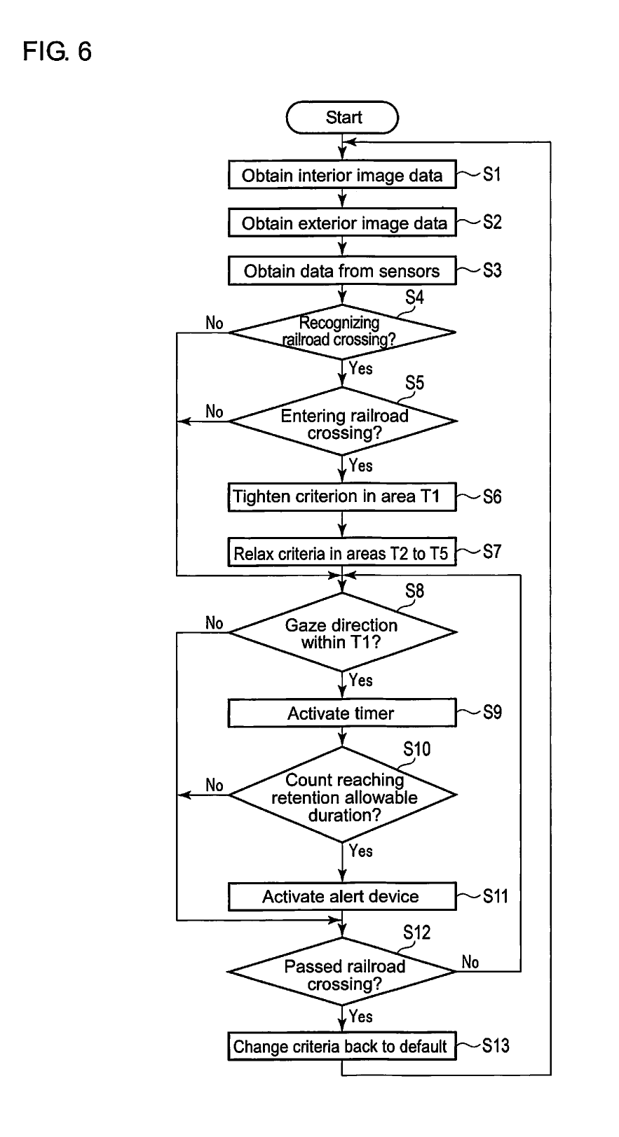

FIG. 6 is a flowchart showing an example procedure performed by the alert control apparatus according to one or more embodiments. In FIG. 6, the interior view camera 6 captures images of the driver 60, and outputs the image data signal a to the alert control apparatus 300. The image data signal a is transferred to the interior image data obtaining unit 41 through the input/output interface unit 30, and is converted into the image data A and stored in the interior image data storage 52 (S1).

The exterior view camera 13 captures images in front of the vehicle 1, and outputs the image data signal h to the alert control apparatus 300. The image data signal h is transferred to the exterior image data obtaining unit 42 through the input/output interface unit 30, and is converted into the image data H and stored in the exterior image data storage 54 (S2).

Further, the signals corresponding to the results detected by the direction indicator switch 7, the steering angle sensor 8, the speed sensor 9, the yaw rate sensor 10, the lateral acceleration sensor 11, the GPS sensor 12, and the exterior sensor 14, as well as the received signal received by the interior-exterior coordinator 15 are also output to the alert control apparatus 300. These signals are obtained by the sensing data obtaining unit 43 through the input/output interface unit 30 (S3).

Through the above processing, the sensing data obtaining unit 43 receives direction indicator information B from the direction indicator signal b, steering angle information C from the steering angle signal c, speed information D from the detection signal d, yaw rate information E from the detection signal e, lateral acceleration information F from the detection signal f, the position information G from the detection signal g, distance information I from the sensing signal i, and the traffic and other information J from the received signal j. Steps S1 to S3 may not be performed in the order illustrated in the figure. In the processing performed by the processor, steps S1 to S3 are performed substantially in parallel.

For a railroad crossing in front of the vehicle 1 in the traveling direction, the railroad crossing recognizer 44 recognizes the railroad crossing based at least on the position information G, the traffic and other information J, the image data H, or the map data Y (Yes in step S4). The railroad crossing recognizer 44 then outputs the crossing recognition signal m to the criterion changer 46. The processing then advances to step S5.

When no railroad crossing is in front of the vehicle 1 in the traveling direction, the railroad crossing recognizer 44 does not recognize any railroad crossing (No in step S4). The processing then advances to step S8.

In step S5, the crossing entry determiner 45 determines whether the vehicle 1 enters the railroad crossing (S5). The crossing entry determiner 45 compares the position data about the vehicle 1 and the position data about the railroad crossing included in the map data, and determines that the vehicle 1 has entered the railroad crossing when the position of the vehicle 1 matches the coordinates indicating the position of the railroad crossing (Mode 1).

In some embodiments, the crossing entry determiner 45 detects entry into the railroad crossing based on the exterior image data H that has undergone image processing. For example, the crossing entry determiner 45 determines that the vehicle 1 has entered the railroad crossing when the railroad crossing is detected through image processing of the exterior image data H (Mode 2).

In some embodiments, the crossing entry determiner 45 detects entry into the railroad crossing based on the surrounding data about the vehicle 1 obtained by the interior-exterior coordinator 15. For example, the crossing entry determiner 45 determines that the vehicle 1 has entered the railroad crossing when the surrounding data indicates the vehicle 1 currently passing the railroad crossing (Mode 3).

When the crossing entry determiner 45 detects entry of the vehicle 1 into the railroad crossing based on any of the modes or any combination of these (Yes in step S5), the crossing entry determiner 45 outputs the determination signal n to the criterion changer 46.

The criterion changer 46 then sets the retention allowable duration for the area T1 in FIG. 4 (tightening the criterion in S6), and restricts generation of an alert to distracted driving in the areas T2 to T5 (relaxing the criterion in S7). In other words, when the entry into the railroad crossing is detected, step S8 and subsequent steps are performed using the updated criterion P.

When the entry of the vehicle 1 into the railroad crossing is not detected in step S5 (No in step S5), step S8 and the subsequent steps are performed using the default criterion P.

In step S8, the gaze direction determiner 47 determines the gaze direction R of the driver 60 based on the face orientation or gaze of the driver 60 captured in the image data

A. When the gaze direction R is retained within any of the areas T2 to T5 (No in step S8), the gaze direction determiner 47 determines not to activate the distracted driving alert device 200. The processing then returns to step S1.

When the gaze direction R is retained within the area T1 (Yes in step S8), the gaze direction determiner 47 activates the timer 47a (S9). The timer 47a then counts the time for which the gaze direction R is retained within the area T1. The gaze direction determiner 47 then determines whether the count reaches the retention allowable duration set for the corresponding area (S10).

When the driver 60 changes his or her gaze direction R out of the area T1 before the count reaches the retention allowable duration (No in step S10), the count is reset. The processing then returns to step S1. In this case, no alert is generated.

When the count of the timer 47a reaches the retention allowable duration (Yes in step S10), the gaze direction determiner 47 outputs the activation signal q to the alert controller 48. In response to the activation signal q, the alert controller 48 outputs the warning instruction signal k to the distracted driving alert device 200 through the input/output interface unit 30. The distracted driving alert device 200 generates an alert (S11).

When the crossing entry determiner 45 determines that the vehicle 1 finishes passing the railroad crossing in step S12 (Yes in S12), the criterion changer 46 changes the determination criteria changed in steps S6 and S7 back to the default values instep S13. When the crossing entry determiner 45 does not determine that the vehicle 1 finishes passing the railroad crossing (No in S12), the processing returns to step S8 and the processing from steps S8 to S12 is repeated.

### Advantages and Effects

As described above, in response to detected entry of the vehicle into a railroad crossing, the distracted driving alert device 200 in the present embodiment operates in a manner opposite to the originally intended manner, or specifically disables the gaze determination in the distracted driving direction and sets the retention allowable duration for the gaze determination in front. In other words, the distracted driving alert device 200 in the present embodiment, which restricts distracted driving, rather prompts distracted driving when the vehicle passes a railroad crossing.

This structure alerts a driver looking too long in front at a railroad crossing, and prompts the driver to move his or her gaze laterally. The alert control apparatus according to the present embodiment effectively prompts, with the distracted driving alert device, the driver of the vehicle to look to the right and left for safety checking in a situation that takes attention in driving, such as when passing a railroad crossing. This structure facilitates safe driving of the driver further.

In the above embodiment, the determination criterion for distracted driving is changed in steps S6 and S7 upon detection of the vehicle 1 entering a railroad crossing. In actual operations, the determination criterion for distracted driving is changed when the vehicle 1 reaches a stop position before entering a railroad crossing. This allows the driver to reliably look to the right and left for safety checking before the vehicle 1 enters the railroad crossing.

In the above embodiment, the vehicle 1 passing a railroad crossing is recognized as a situation that takes attention in driving. The situation that takes attention in driving is not limited to this, but includes, for example, an emergency vehicle approaching the vehicle 1. The technical concept of the present invention is also applicable to this case.

For example, image data from the exterior view camera 13 is analyzed. When an emergency vehicle approaching in the travelling direction of the vehicle 1 is recognized, the criterion for generating an alert is changed. When the exterior sensor 14 includes a microphone, voice data output from this microphone may be used to recognize an approaching emergency vehicle. More specifically, when a pattern similar to the spectrum of an alert sound from the emergency vehicle is detected through the spectral analysis of the voice data, an approaching emergency vehicle may be recognized.

The above operation may be implemented by replacing step S4 with “An emergency vehicle recognized?”, step S5 with “An emergency vehicle approaching?”, and step S12 with “An emergency vehicle moving away?” in the flowchart shown in FIG. 6 and elsewhere.

The alert control apparatus according to each of the above embodiments and its components may be implemented by hardware or a combination of hardware resources and software. The software to be combined is a program preliminarily installed in a computer through a network or from a computer readable recording medium, and executed by a processor included in the computer to perform the operation of each unit.

A processor used in association with a computer or the term processor herein includes a circuit such as a CPU, a graphics processing unit (GPU), an application specific integrated circuit (ASIC), a simple programmable logic device (SPLD), a complex programmable logic device (CPLD), and an FPGA.

The processor reads a program stored in the memory and executes the program to implement the specific processing based on the program. The program may not be stored in the memory but may be directly incorporated in the circuit of the processor. In that case, the processor reads the program incorporated in the circuit to perform the processing.

### Other Embodiments

Although the present invention has been described based on the specific embodiments with reference to the drawings, the present invention is not limited to the above embodiments. Variations and modifications will occur to those skilled in the art within the spirit and scope of the present invention defined by the claims. Such variations and modifications can fall within the technical scope of the present invention.

The present embodiment may be partially or entirely expressed in, but not limited to, the following forms shown in the appendixes below.

### Appendix 1

An alert control apparatus installable in a vehicle to control an alert device that alerts a driver, the apparatus comprising a hardware processor configured to obtain sensing data from a sensor included in the vehicle;

detect a gaze or a face orientation of the driver based on the obtained sensing data;

determine distracted driving of the driver based on the detected gaze or face orientation and a determination criterion for detecting distracted driving of the driver;

cause the alert device to generate an alert in response to detection of distracted driving;

recognize a situation that takes attention in driving the vehicle based on the obtained sensing data; and

control the alert device to prompt the driver to move the gaze in the situation that takes attention in driving the vehicle based on a recognition result.

### Appendix 2

An alert control method implemented by an alert control apparatus installable in a vehicle to control an alert device that alerts a driver, the method comprising:

obtaining, with at least one hardware processor, sensing data from a sensor included in the vehicle;

detecting, with the at least one hardware processor, a gaze or a face orientation of the driver based on the obtained sensing data;

determining, with the at least one hardware processor, distracted driving of the driver based on the detected gaze or face orientation and a determination criterion for detecting distracted driving of the driver;

causing, with the at least one hardware processor, the alert device to generate an alert in response to detection of distracted driving;

recognizing, with the at least one hardware processor, a situation that takes attention in driving the vehicle based on the obtained sensing data; and

controlling, with the at least one hardware processor, the alert device to prompt the driver to move the gaze in the situation that takes attention in driving the vehicle based on a recognition result.

### REFERENCE SIGNS LIST

1: vehicle, 2: power unit, 3: steering unit, 4: steering wheel, 6: interior view camera, 7: direction indicator switch, 8: steering angle sensor, 9: speed sensor, 10: yaw rate sensor, 11: lateral acceleration sensor, 12: GPS sensor, 13: exterior view camera, 14: exterior sensor, 15: interior-exterior coordinator, 30: input/output interface unit, 40: control unit, 41: interior image data obtaining unit, 42: exterior image data obtaining unit, 43: sensing data obtaining unit, 44: railroad crossing recognizer, 45: crossing entry determiner, 46: criterion changer, 47a: timer, 47: gaze direction determiner, 48: alert controller, 49: gaze detector, 50: memory, 52: interior image data storage, 54: exterior image data storage, 55: map data storage, 56: criterion storage, 60: driver, 70: right side mirror, 71: left side mirror, 100: sensor, 200: distracted driving alert device, 300: alert control apparatus

1. An alert control apparatus installable in a vehicle to control an alert device that alerts a driver, the apparatus comprising:
a data obtaining unit configured to obtain sensing data from a sensor included in the vehicle;
a gaze detector configured to detect a gaze or a face orientation of the driver based on the obtained sensing data;
a distracted driving determiner configured to determine distracted driving of the driver based on the detected gaze or face orientation and a determination criterion for detecting distracted driving of the driver;
a controller configured to cause the alert device to generate an alert in response to detection of distracted driving; and
a recognizer configured to recognize a situation that takes attention in driving the vehicle based on the obtained sensing data,
wherein the controller controls, based on a recognition result from the recognizer, the alert device to prompt the driver to move the gaze in the situation that takes attention in driving the vehicle.

2. The alert control apparatus according to claim 1, wherein
the controller changes the determination criterion to a determination criterion for prompting the driver to change the gaze or the face orientation in the situation that takes attention in driving the vehicle.

3. The alert control apparatus according to claim 2, wherein
the determination criterion includes a retention allowable duration for which the driver is allowed to retain a gaze or a face orientation within an imaginary area defined for detecting distracted driving, and
the controller sets a retention allowable duration to retain the gaze or the face orientation within a first area defined in front of the vehicle shorter than a retention allowable duration to retain the gaze or the face orientation within a second area defined in a direction for the distracted driving.

4. The alert control apparatus according to claim 1, further comprising:
a storage configured to store map data including at least position data about a place where attention is to be taken in driving, wherein
the sensing data includes position data about the vehicle,
the data obtaining unit obtains the position data about the vehicle based on a positioning signal from a positioning system, and
the recognizer recognizes the situation that takes attention in driving based on the obtained position data about the vehicle and the position data included in the map data.

5. The alert control apparatus according to claim 1, wherein
the vehicle includes an exterior view camera configured to obtain image data about a view external to the vehicle,
the data obtaining unit obtains the image data from the exterior view camera, and
the recognizer subjects the image data to image processing, and uses the processed image data to recognize the situation that takes attention in driving.

6. The alert control apparatus according to claim 1, wherein
the vehicle is configured to communicate with a vehicle-to-roadside communication system or a vehicle-to-vehicle communication system,
the data obtaining unit obtains surrounding data about the vehicle from the communication system, and
the recognizer recognizes, based on the surrounding data, the situation that takes attention in driving.

7. The alert control apparatus according to claim 4, wherein
the recognizer recognizes a duration for which the vehicle is passing a railroad crossing as the situation that takes attention in driving.

8. The alert control apparatus according to claim 5, wherein
the recognizer recognizes a duration for which the vehicle is passing a railroad crossing as the situation that takes attention in driving.

9. The alert control apparatus according to claim 6, wherein
the recognizer recognizes a duration for which the vehicle is passing a railroad crossing as the situation that takes attention in driving.

10. The alert control apparatus according to claim 5, wherein
the recognizer recognizes an approaching emergency vehicle as the situation that takes attention in driving.

11. The alert control apparatus according to claim 6, wherein
the recognizer recognizes an approaching emergency vehicle as the situation that takes attention in driving.

12. An alert control method implemented by an alert control apparatus installable in a vehicle to control an alert device that alerts a driver, the method comprising:
obtaining, with the alert control apparatus, sensing data from a sensor included in the vehicle;
detecting, with the alert control apparatus, a gaze or a face orientation of the driver based on the obtained sensing data;
determining, with the alert control apparatus, distracted driving of the driver based on the detected gaze or face orientation and a determination criterion for detecting distracted driving of the driver;
causing, with the alert control apparatus, the alert device to generate an alert in response to detection of distracted driving;
recognizing, with the alert control apparatus, a situation that takes attention in driving the vehicle based on the obtained sensing data; and
controlling, with the alert control apparatus, the alert device to prompt the driver to move the gaze in the situation that takes attention in driving the vehicle based on a recognition result.

13. A non-transitory recording medium having a program recorded thereon that is executable to cause a computer to implement processes performed by the units included in the alert control apparatus according to claim 1.

14. A non-transitory recording medium having a program recorded thereon that is executable to cause a computer to implement processes performed by the units included in the alert control apparatus according to claim 2.

15. A non-transitory recording medium having a program recorded thereon that is executable to cause a computer to implement processes performed by the units included in the alert control apparatus according to claim 3.

16. A non-transitory recording medium having a program recorded thereon that is executable to cause a computer to implement processes performed by the units included in the alert control apparatus according to claim 4.

17. A non-transitory recording medium having a program recorded thereon that is executable to cause a computer to implement processes performed by the units included in the alert control apparatus according to claim 5.

18. A non-transitory recording medium having a program recorded thereon that is executable to cause a computer to implement processes performed by the units included in the alert control apparatus according to claim 6.

19. A non-transitory recording medium having a program recorded thereon that is executable to cause a computer to implement processes performed by the units included in the alert control apparatus according to claim 7.

20. A non-transitory recording medium having a program recorded thereon that is executable to cause a computer to implement processes performed by the units included in the alert control apparatus according to claim 8.

21. A non-transitory recording medium having a program recorded thereon that is executable to cause a computer to implement processes performed by the units included in the alert control apparatus according to claim 9.

22. A non-transitory recording medium having a program recorded thereon that is executable to cause a computer to implement processes performed by the units included in the alert control apparatus according to claim 10.

23. A non-transitory recording medium having a program recorded thereon that is executable to cause a computer to implement processes performed by the units included in the alert control apparatus according to claim 11.
